(19) United States
(12) Patent Application Publication
(10) Pub. No.: US 2004/0044697 A1
(43) Pub. Date: Mar. 4, 2004

(54) Systems and methods for distributing, obtaining and using digital media files

(76) Inventor: Michael L. Nixon, Spanish Fork, UT (US)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/637,830

(22) Filed: Aug. 7, 2003

Related U.S. Application Data
(60) Provisional application No. 60/406,615, filed on Aug. 28, 2002.

(51) Int. Cl. G06F 12/00

(52) U.S. Cl. 707/200

(57) ABSTRACT

Systems and methods for distributing, obtaining and using digital media files are disclosed. An exemplary method for distributing media files may include receiving a digital media file from a media file server. A plurality of digital media files are stored on the file server. In addition, a plurality of other media vending devices are also in electronic communication with the media file server. A request may then be received to transmit a copy of the digital media file to a portable electronic device. License information uniquely associated with the copy of the digital media file may then be determined. The copy of the digital media file and the license information may then be transmitted to the portable electronic device.

### RELATED APPLICATIONS

This application is related to and claims priority from U.S. patent application Ser. No. 60/406,615 filed Aug. 28, 2002, for “A Device and Method for Downloading Video from Video/Media Kiosks and Stores to Portable Devices,” with inventor Michael L. Nixon, which is incorporated herein by reference.

### TECHNICAL FIELD

The present invention relates generally to digital media. More specifically, the present invention relates to improved systems and methods for distributing, obtaining and using digital media files.

### BACKGROUND

Many types of media, such as movies, music, television programs, electronic books, and so forth, are now available in a digital format. Consumers who wish to view, listen to, read, or otherwise make use of digital media typically either purchase the right to have the media broadcast to them, or they purchase or rent physical copies of the media. For example, consumers may subscribe to broadcast services such as digital cable, direct broadcast satellite (DBS), video-on-demand (VoD), or the like. Alternatively, consumers may purchase or rent compact discs (CDs) or digital versatile disks (DVDs).

With broadcasting systems, recording and playback is generally difficult, so customers are ordinarily only allowed to receive a program in a fixed period. This is often inconvenient for many consumers, particularly those with nontraditional work schedules. In addition, in order to generate revenue, television programming is often frequently interrupted with advertisements. Such advertisements may be quite annoying to individuals who are not interested in what is being advertised.

The purchase of physical copies of digital media, such as CDs and/or DVDs, allows media content to be presented when the consumer wishes it to be presented. However, when a consumer purchases media content, he or she pays a relatively steep price for the content regardless of how many times the content is used. This can be frustrating to an individual who does not wish to use the media more than a few times. In the case of a rental, the user is burdened by the need to return the physical copy of the media (e.g., a DVD) within a required amount of time, or face additional rental fees. In addition, a consumer who wishes to rent a particular selection may be frustrated when, after traveling to the rental store, he or she finds out that the desired selection is presently out of stock.

Despite the popularity and widespread availability of the Internet, only a limited amount of digital media content is presently available on the Internet (at least from authorized sources). Because digital content may be copied with perfect accuracy, content producers, such as movie studios and television networks, are reluctant to make digital versions of their products available on the Internet without assurances that the products will not be copied without authorization. However, the recent controversies concerning the unauthorized downloading of MP3 files through systems such as Napster, Kazaa, and the like, has only heightened the concerns of content providers.

Accordingly, benefits may be realized by improved systems and methods for distributing, obtaining and using digital media files.

### SUMMARY OF THE INVENTION

A method for distributing digital media files is disclosed. The method may be implemented by a media vending device that is in electronic communication with a media file server. A plurality of digital media files may be stored on the media file server. In addition, a plurality of other media vending devices may also be in electronic communication with the media file server. The media vending devices may be located at a public location.

The method may involve receiving one or more digital media files from the media file server, and then storing the received digital media files. Information may be provided to a user about available digital media files. A user request may be received to transmit a copy of a particular digital media file to a portable electronic device. Payment information may also be received from the user. License information that is uniquely associated with the copy of the digital media file may be determined. This may involve providing the user with a plurality of license options for the digital media file, and then receiving a user selection of one of the plurality of license options. The license information may be determined based on the selected license option. The copy of the digital media file and the license information may be transmitted to the portable electronic device. The copy of the digital media file may be encrypted using an encryption key that is uniquely associated with the portable electronic device. The payment information previously received from the user may be transmitted to a payment processing server.

A media vending device for implementing the above-described method is also disclosed. The media vending device may include a processor and memory in electronic communication with the processor. The media vending device may also include a media file server communication interface for electronic communication with the media file server, and a portable electronic device communication interface for electronic communication with the portable electronic device. The media vending device may also include instructions stored in the memory. The instructions are executable by the processor to implement the method described above. In some embodiments, the media vending device communication interface includes a communication port and connector configured to electrically connect the communication port to a corresponding communication port on the media vending device.

A method for obtaining and using digital media files is also disclosed. The method may be implemented by a portable electronic device that is in electronic communication with the media vending device. The method may involve receiving a copy of a digital media file from the media vending device. In embodiments where the copy of the digital media file is encrypted, the method may also involve decrypting the copy of the digital media file. License information may also be received from the media vending device. The license information may be uniquely associated with the copy of the digital media file. A user request may be received to produce a user-perceptible form of the digital media file. The portable electronic device may then determine whether the license information permits fulfillment of the request. If the license information permits fulfillment of the request, then the request may be fulfilled. In some embodiments, fulfilling the request involves producing the user-perceptible form of the media file on an output device that is part of the portable electronic device. Alternatively, or in addition, fulfilling the request may involve producing the user-perceptible form of the media file on a separate output device.

A portable electronic device for implementing the above-described method is also disclosed. The portable electronic device may include a processor and memory in electronic communication with the processor. The portable electronic device may also include an input device and a media vending device communication interface for electronic communication with the media vending device. The portable electronic device may also include instructions stored in the memory. The instructions are executable by the processor to implement the method described above.

### BRIEF DESCRIPTION OF THE DRAWINGS

The present embodiments will become more fully apparent from the following description and appended claims, taken in conjunction with the accompanying drawings, Understanding that these drawings depict only typical embodiments and are, therefore, not to be considered limiting of the invention's scope, the embodiments will be described with additional specificity and detail through use of the accompanying drawings in which:

FIG. 1 is a block diagram illustrating an embodiment of a system for distributing digital media files;

FIG. 2 is a block diagram illustrating the components typically utilized in a vending device and/or portable device used with embodiments herein;

FIG. 3 is a flow diagram illustrating an embodiment of a method for distributing digital media files;

FIG. 4 is a flow diagram illustrating an embodiment of a method for obtaining and using digital media files;

FIG. 5 is a functional block diagram illustrating how media files may be encrypted and license information may be generated in an embodiment of a media vending device;

FIG. 6 is a block diagram illustrating one exemplary way in which electronic communication may occur between a vending device and a portable device; and

FIG. 7 is a block diagram illustrating an alternative embodiment of a system for distributing digital media files.

### DETAILED DESCRIPTION

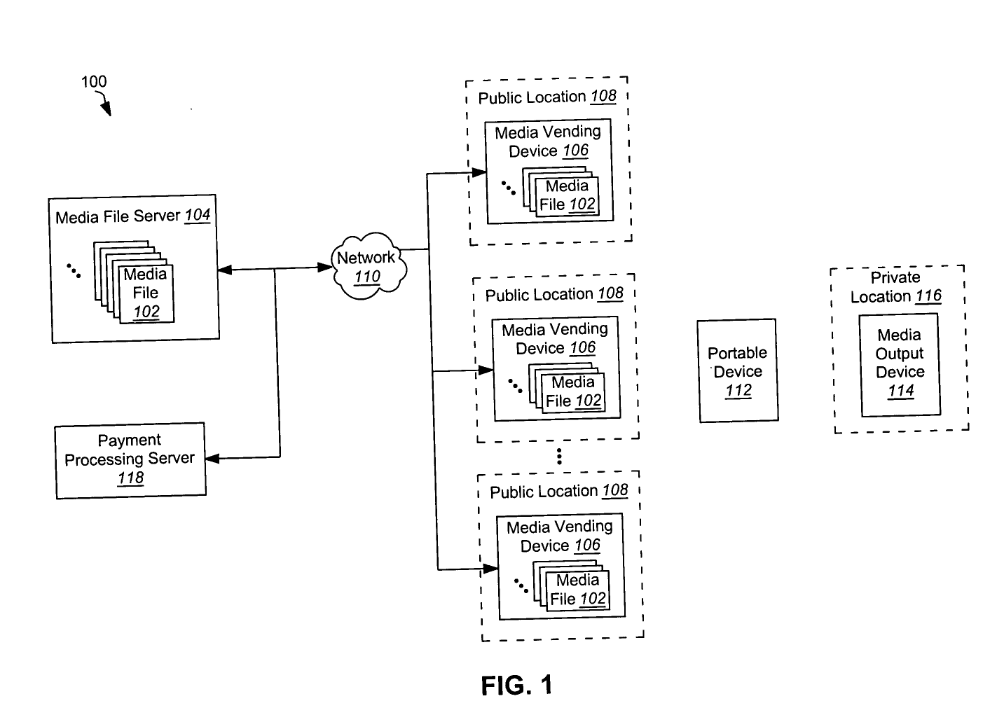

It will be readily understood that the components of the present invention, as generally described and illustrated in the Figures herein, could be arranged and designed in a wide variety of different configurations. Thus, the following more detailed description of several exemplary embodiments of the present invention, as represented in FIGS. 1 through 7, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Those skilled in the art will appreciate that many features of the embodiments disclosed herein may be implemented as electronic hardware, computer software, or combinations of both. To clearly illustrate this interchangeability of hardware and software, various illustrative modules will be described generally in terms of their functionality. Whether such “functional modules” are implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the functional modules described below are implemented as computer software, such “software modules” may include any type of computer instruction or computer executable code located within a memory device and/or transmitted as electronic signals over a system bus or network. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction, or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

FIG. 1 is a block diagram illustrating an embodiment of a system 100 for distributing digital media files 102. The system 100 includes a media file server 104, and various media vending devices 106 in electronic communication with the media file server 104. The vending devices 106 are generally located at public locations 108, such as stores, airports, stadiums, theaters, and the like.

A large number of digital media files 102 are stored on the media file server 104. Copies of some or all of the media files 102 stored on the file server 104 are stored on the vending devices 106. These media files 102 are typically transmitted from the file server 104 to the vending devices 106 at various times. For example, the file server 104 may transmit media files 102 to the vending devices 106 in response to requests from the vending devices 106. Alternatively, or in addition, the file server 104 may transmit media files 102 to the vending devices 106 at regular intervals, whether or not any requests have been received from the vending devices 106. In some embodiments, the file server 104 has a considerably larger storage capacity than the video vending devices 106, so only the most popular media files 102 are transmitted to and stored on the vending devices 106.

As shown, the file server 104 and the vending devices 106 may be interconnected via one or more computer networks 110. Thus, data transmitted from the file server 104 may pass through one or more intermediate nodes en route to a vending device 106 (or vice versa). The embodiments disclosed herein are not limited to any specific type of network 110.

People who wish to view, listen to, read, or generally make use of some or all of the media files 102 may download the desired media files 102 from one of the vending devices 106 using a portable electronic device 112. Exemplary methods for downloading media files 102 from the vending devices 106 are described below. Once obtained, user-perceptible forms of the media files 102 may then be produced on the portable device 112 itself or on a separate media output device 114. The media output device 114 may be located at a private location 116, such as a person's home.

As used herein, a “user-perceptible form” of a media file 102 refers broadly to any way in which a user may experience or sense a media file 102. For example, where the media file 102 is a video file, the user generally sees moving images and hears sound associated with those images. Where the media file 102 is an audio file, the user generally hears sound. Where the media file 102 is an electronic book, the user generally sees text and/or associated pictures. Other ways in which users may perceive different types of media files 102 will be readily apparent to those skilled in the art.

Individuals who download media files 102 from the vending devices 106 generally provide payment information (e.g., credit card numbers, debit card numbers, bank account numbers, and so forth) in order to pay for their use of the media files 102. This information is generally provided to a payment processing server 118, which processes the payment information. The payment processing server 118 may also forward royalties to the appropriate parties. The payment processing server 118 is shown in electronic communication with the vending devices 106. Although they are shown separately in FIG. 1, in some embodiments the file server 104 and the payment processing server 118 may be running on the same computing device or computing system.

Throughout this discussion, a user who downloads a media file 102 and pays for its use will be said to have “licensed” the media file 102. The term “licensed” should be construed broadly to include the situation where an individual pays for the permanent, unlimited use of a media file 102.

Although the vending device 106 and output device 114 are shown in FIG. 1 as unitary components, it will be understood that the vending device 106 and output device 114 may consist of multiple components which together implement the described functionality. For example, the vending device 106 and/or the media output device 114 may include a separate “cradle” to which the portable device 112 connects.

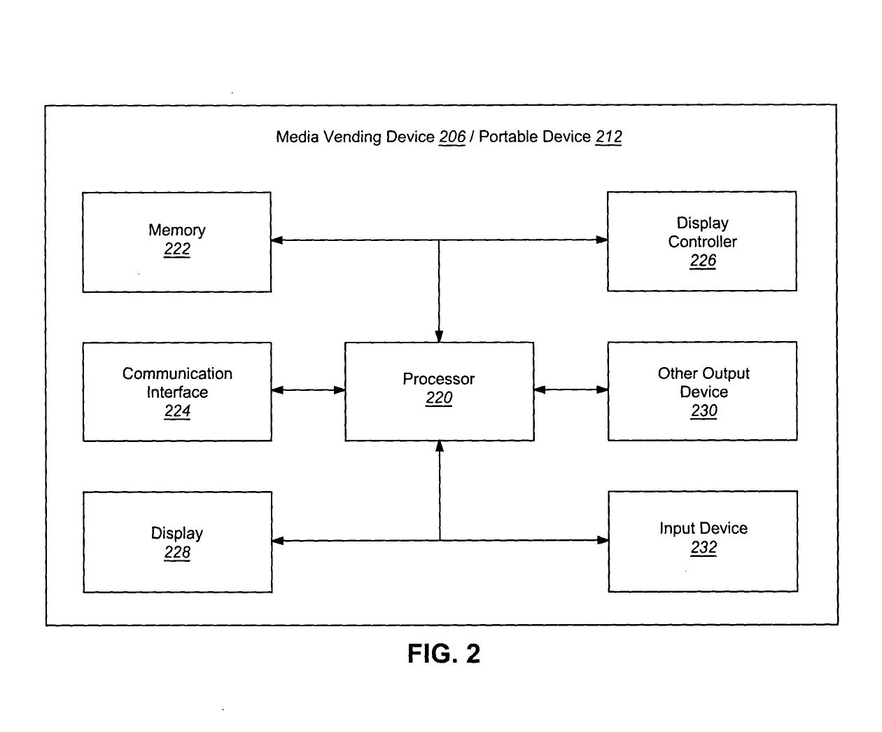

FIG. 2 is a block diagram illustrating the components typically utilized in a vending device 206 and/or portable device 212 used with embodiments herein. The illustrated components may be logical or physical and may be implemented using any suitable combination of hardware, software, and/or firmware. In addition, the different components may be located within the same physical structure or in separate housings or structures.

The device shown in FIG. 2 includes a processor 220 and memory 222. The processor 220 controls the operation of the device and may be embodied as a microprocessor, a microcontroller, a digital signal processor (DSP) or other device known in the art. The processor 220 typically performs logical and arithmetic operations based on program instructions stored within the memory 222.

As used herein, the term “memory” 222 is broadly defined as any electronic component capable of storing electronic information, and may be embodied as read only memory (ROM), random access memory (RAM), magnetic disk storage media, optical storage media, flash memory devices in RAM, on-board memory included with the processor 220, EPROM memory, EEPROM memory, registers, etc. Whatever form it takes, the memory 222 typically stores digital media files 102, instructions, and other types of data. The instructions are generally executed by the processor 220 to implement some or all of the methods disclosed herein.

Vending devices 206 and/or portable devices 212 typically also include one or more communication interfaces 224. A vending device 206 generally includes at least one communication interface 224 for communicating with the file server 104 and at least one communication interface 224 for communicating with a portable device 212. A vending device 206 may include one or more communication interfaces 224 that are specifically dedicated to communication with the file server 104, and one or more communication interfaces 224 that are specifically dedicated to communication with portable devices 212. For example, a vending device 206 may include a network interface card for receiving data from the file server 104 over a network 110, and a high-speed communication port for transmitting data to portable devices 212. In some embodiments, however, a single communication interface 224 may be used for communication with the file server 104 and with the portable devices 212.

A portable device 212 generally includes at least one communication interface 224 for communicating with a vending device 206, and at least one communication interface 224 for communicating with a media output device 114. The portable device 212 may include one or more communication interfaces 224 that are specifically dedicated to communication with a vending device 206, and one or more communication interfaces 224 that are specifically dedicated to communication with a media output device 114. For example, the portable device 212 may include a high-speed data port for receiving data from a vending device 206, and video output jacks for providing video signals to a television. In some embodiments, however, a single communication interface 224 may be used to communicate with a vending device 206 and with a media output device 114.

The vending device 206 and/or portable device 212 may also include a display controller 226. Where digital media files 102 include visually perceptible information, the display controller 226 controls the display of such information on a display. In other words, the display controller 226 converts the digital media files 102 stored in the memory 222 into text, graphics, and/or moving images (as appropriate, depending on the type of media file 102 involved) shown on a display. Examples of different types of display controllers 226 include a display adapter, display processor, video processing unit, graphics card, graphics accelerator, or the like.

The vending device 206 and/or the portable device 212 may include a display 228. Visually perceptible information from media files 102 may be shown on the display 228 included with the portable device 112. Alternatively, or in addition, such information may be displayed on an external display, such as a television, computer monitor, or the like. Displays 228 used with embodiments disclosed herein may utilize any suitable image projection technology, such as a cathode ray tube (CRT), liquid crystal display (LCD), light-emitting diode, gas plasma, or the like.

The vending device 206 and/or portable device 212 may also include one or more other output devices 230, as well as one or more input devices 232. Examples of different kinds of output devices 230 include a speaker, printer, etc. Examples of different kinds of input devices 232 include a button, keyboard, mouse, joystick, etc.

Of course, FIG. 2 illustrates only one possible configuration of a vending device 206 and/or portable device 212. Those skilled in the art will recognize that various other architectures and components may be provided within the scope of the invention. In addition, various standard components are not illustrated in order to avoid obscuring aspects of the invention.

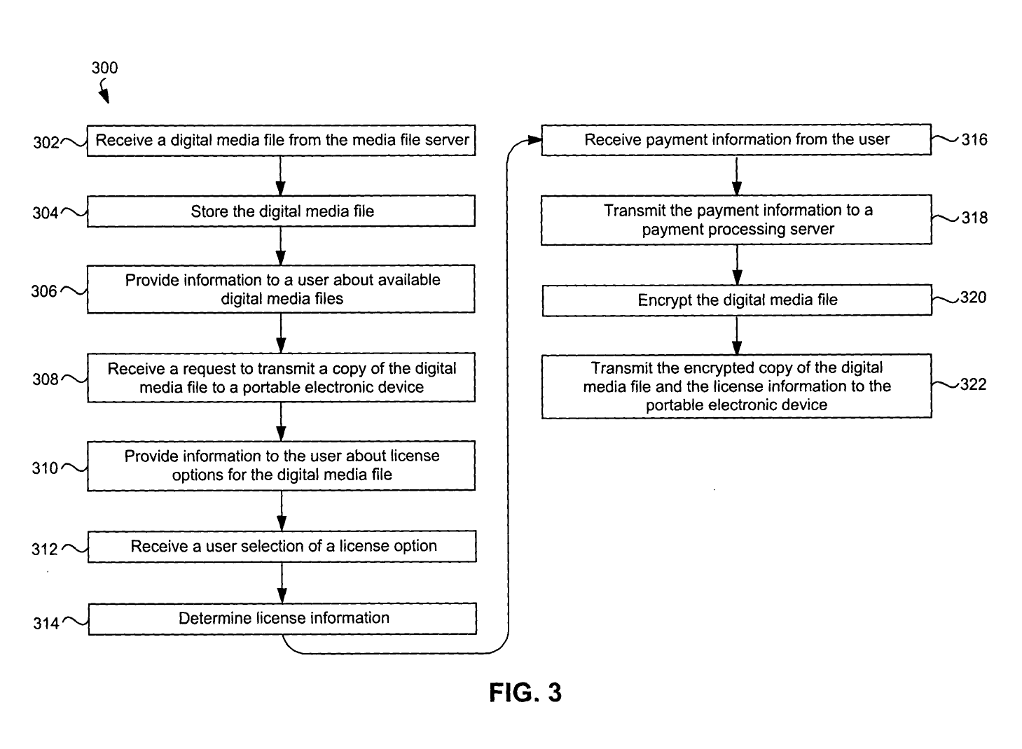

FIG. 3 is a flow diagram illustrating a method 300 for distributing digital media files 102. The method 300 shown in FIG. 3 is typically performed by a vending device 106. For clarity, the method 300 will be discussed in relation to a single digital media file 102. However, multiple media files 102 may be distributed in accordance with the method 300. Also, those skilled in the art will recognize some of the depicted steps may be omitted and the order of some or all of the steps may be changed without departing from the spirit or scope of embodiments disclosed herein.

The method 300 begins when the vending device 106 receives 302 a digital media file 102 from the media file server 104. In some embodiments, the vending device 106 may receive 302 the media file 102 in response to a request that the vending device 106 has made to the file server 104. Alternatively, the file server 104 may transmit media files 102 to the vending device 106 on its own initiative. For example, the file server 104 may transmit media files 102 to the vending device 106 at regular intervals (e.g., daily, weekly, etc.), whenever a specified event occurs (a new media file 102 is released, a particular media file 102 achieves a certain level of popularity, etc.), or even randomly. Media files 102 that are received from the file server 104 are typically stored 304 in memory 222 within the vending device 106.

In some embodiments, digital media files 102 stored on the media file server 104 may be sent to the vending device 106 by means other than electronic communication. For example, digital media files 102 may be saved onto an electronic storage medium (e.g., DVD, CD, memory stick, floppy disk, etc.) and sent through the mail to the operators of the vending device 106. The operators of the vending device may then transfer the media files 102 from the electronic storage medium to the vending device 106.

As discussed previously, portable devices 112 are typically used to download media files 102 from vending devices 106. An individual who wishes to obtain digital media content generally brings a portable device 112 in close physical proximity to a vending device 106, so that electronic communication between the vending device 106 and the portable device 112 may occur. For example, if the vending device 106 were located at a store, the individual would generally enter the store with the portable device 112, and then proceed to the general vicinity of the store where the vending device 106 is located. In some embodiments, the user physically connects the portable device 112 to the vending device 106, for example via electrical connectors or cables. Alternatively, communication between the vending device 106 and the portable device 112 may be wireless.

The vending device 106 then provides 306 information to the individual, or “user,” about media files 102 that are available for license. The information typically relates to media files 102 that are stored on the vending device 106, although the vending device 106 may also provide information about media files 102 that are stored on the file server 104 and that may be downloaded to the vending device 106. The information is generally provided through one or more output devices, such as a display screen, speaker, printer, etc.

After viewing the available media files 102 and selecting one to be licensed, the user communicates his or her selection to the vending device 106. This may be done using one or more input devices 232 on the vending device 106 and/or the portable device 112. Consequently, the vending device 106 typically receives 308 the user's selection either directly through an input device 232 on the vending device 106, or indirectly from the portable device 112. The user's selection of a particular media file 102 is generally interpreted by the vending device 106 as a request to transmit the selected media file 102, and more specifically a copy of the selected media file 102, to the user's portable device 112.

The vending device 106 then provides 310 information to the user about license options for the media file 102. Many different license options may be made available to users. For example, the user may wish to license the media file 102 for a certain period of time (e.g., 5 days), during which time the media file 102 may be used an unlimited number of times. Alternatively, the user may wish to license the media file 102 for a specified number of uses (e.g., a video may be viewed 2 times), which may take place over an unlimited period of time. Alternatively still, the user may wish to purchase an unrestricted license for the media file 102, namely, that the media file 102 may be used an unlimited number of times over an unlimited period of time. Those skilled in the art will recognize other types of license options that may be available to a user. As with the information about available media files 102, information about the available license options is generally provided to the user via one or more output devices 230 on the vending device 106 and/or the portable device 112.

The user then selects a particular license option and uses one or more input devices 232 (as before, either on the portable device 112 and/or the vending device 106) to communicate this selection to the vending device 106. The vending device 106 receives the user's selection of one of the license options and determines 314 license information that is to be communicated to the portable device 112. The license information enables the portable device 112 to enforce the license that was selected by the user. For example, the license information may include information about the conditions under which a user may make use of a particular media file 102, as well as what types of uses are permitted or excluded.

The license information is generally specific to the different copies of the media file 102 that are made. In other words, different users can license the same media file 102 under different license terms. For example, suppose that two users (user A and user B) wish to license the same media file 102, but under different terms (e.g., user A wants to be able to watch a video once, while user B wants to be able to watch the same video an unlimited number of times over 3 days). Two different copies of the media file 102 are made, one copy to be downloaded to the portable device 112 belonging to user A, and another copy to be downloaded to the portable device 112 belonging to user B. In such a scenario, the license information associated with user A's copy of the media file 102 is different than the license information associated with user B's copy of the media file 102. Moreover, the license information which reflects user A's license is typically only applicable to user A's copy of the media file 102, and the license information which reflects user B's license is typically only applicable to user B's copy of the media file 102. Thus, it may be said that the license information transmitted to user A's portable device is “uniquely associated with” user A's copy of the media file 102, and that the license information transmitted to user B's portable device is “uniquely associated with” user B's copy of the media file 102.

Payment information, such as a credit or debit card number, checking account number, or the like, is then received 316 from the user and transmitted 318 to the payment processing server 118. Known techniques for secure communications (e.g., SSL) may be utilized to transmit 318 the payment information to the payment processing server 118.

The vending device 106 then encrypts 320 the media file 102. In some embodiments, the vending device 106 may use an encryption key that is uniquely associated with the portable device 112, so that the media file 102 may not be used by other portable devices 112. In some embodiments, an encryption key may be associated with the portable device 112 (or with a unique identifier of the portable device 112) in a lookup table that is accessible to the vending device 106. When the vending device 106 prepares to encrypt 320 a media file 102, it may refer to the lookup table to determine the encryption key to be used. Following encryption, the encrypted copy of the media file 102, and the license information associated with that copy of the media file 102, are then transmitted 322 to the portable device 112.

In some embodiments, one or more different kinds of information may be synchronized between the vending device 106 and the portable device 112 when the license information is sent to the portable device 112. For example, the vending device 106 may synchronize a clock on the portable device 112 with a clock on the vending device 106. This may enable the portable device 112 to accurately determine the expiration of a license in situations where, for example, a media file 102 is date-stamped by the vending device 106.

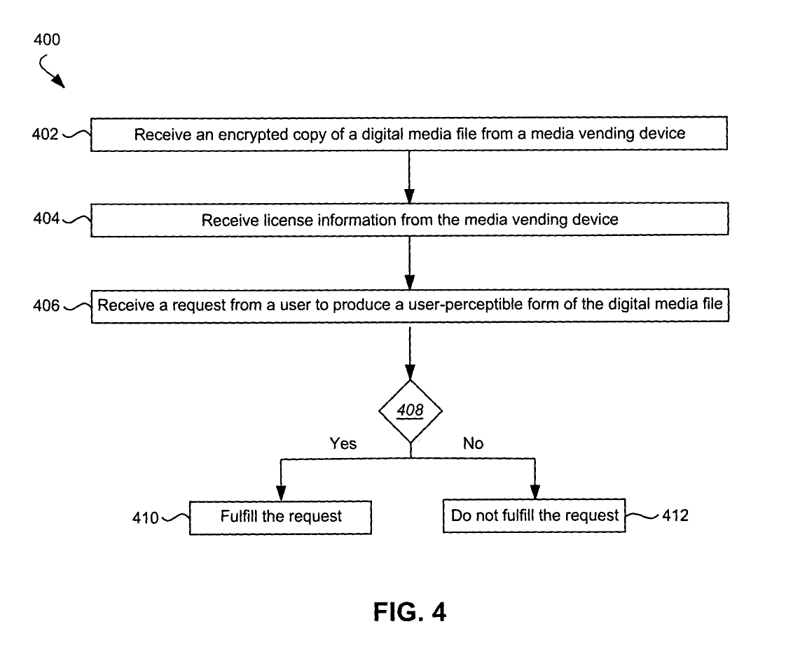

FIG. 4 is a flow diagram illustrating a method 400 for obtaining and using digital media files 102. The method 400 shown in FIG. 4 is typically performed by a portable device 112. As before, the method 400 will be discussed in relation to a single media file 102. However, multiple media files 102 may be obtained and used in accordance with the method 400. Also as before, those skilled in the art will recognize that some of the depicted steps may be omitted and that the order of some or all of the steps may be changed without departing from the scope of the present invention.

The method 400 begins when an encrypted copy of a media file 102 is received 402 from a vending device 106. As discussed previously, the media file 102 is generally encrypted using an encryption key that is specifically associated with the portable device 112. In general, only the vending device 106 and the portable device 112 know what the encryption key is, so that other portable devices 112 will be unable to decrypt, and therefore make use of, the media file 102.

License information is also received 404 from the vending device 106. As discussed previously, the license information generally enables the portable device 112 to enforce the license that was selected by the user of the portable device 112. In general, the license information is uniquely associated with the copy of the media file 102 that is downloaded to the portable device 112.

At some point, the user of the portable device 112 may wish to view, listen to, read, or otherwise make use of the media file 102 received in step 402. In such a situation, the user communicates, and the portable device 112 receives 406, a request to produce a user-perceptible form of the media file 102. The request may be communicated to the portable device by one or more input devices 232 on the portable device 112.

The portable device 112 then determines 408 whether the user's license permits the user's request to be fulfilled. In other words, if the user makes a request to use a particular media file 102, the portable device 112 may determine, by reference to the license information, whether the user is licensed to use the media file 102 in the requested manner. In general terms, a user is not permitted to make use of a media file 102 if the requested use exceeds the scope of the license selected (and paid for) in step 312 of the method 300 illustrated in FIG. 3. There are many ways in which this may occur. For example, a user may not be licensed to view a video file if he or she is licensed to view the video N times and has already viewed the video N times, or if he or she is licensed to view the video for N days, and those N days have passed, etc.

If the portable device 112 determines 408 that the license information permits the user's request to be fulfilled, then the request is fulfilled 410. Typically, fulfilling the request involves decrypting the media file 102 using the encryption key associated with the portable device 112. Where the media file 102 includes visually perceptible information to be shown on a display, the display controller 226 within the portable device 112 may control the display of such information. This may be the case even if the media file 102 is to be played on an external display, such as a television or monitor. Of course, the media file 102 may alternatively be transmitted to an external display unit, and a display controller within the external display unit may control the display of the visually perceptible information. If the portable device 112 determines 408 that the license information does not permit the user's request to be fulfilled, then the request is not fulfilled 412. An error message may be displayed or otherwise communicated to the user if this occurs.

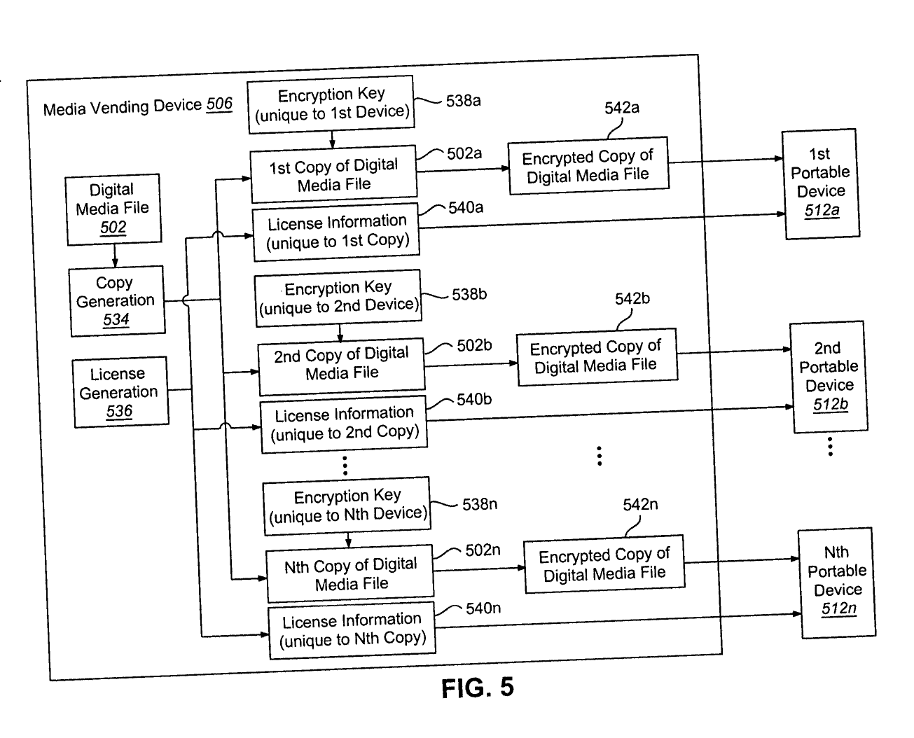

FIG. 5 is a functional block diagram illustrating how media files 502 may be encrypted and license information may be generated in an embodiment of a media vending device 506. In FIG. 5, the media vending device 506 is shown in communication with multiple portable devices 512, namely a first portable device 512a, a second portable device 512b, and an N^{th} portable device 512n. Each portable device 512 has requested a copy of the same media file 502. The media vending device 506 is shown having a copy generation module 534 and a license generation module 536, which are “functional modules,” as that term is defined above.

The copy generation module 534 generates a separate copy of the media file 502 for each portable device 512. More specifically, a first copy 502a of the media file 502 is generated for the first portable device 512a, a second copy 502b of the media file 502 is generated for the second portable device 512b, and an N^{th} copy 512n of the media file 502 is generated for the N^{th} portable device 512n.

Different encryption keys 538 are used to encrypt the different copies of the media file 502. In FIG. 5, a first encryption key 538a is used for the first copy 502a of the media file 502, a second encryption key 538b is used for the second copy 502b of the media file 502, and an N^{th} encryption key 538n is used for the N^{th} copy 502n of the media file 502. The encryption key 538 used to encrypt a particular copy is uniquely associated with the portable device 512 to which the copy is to be downloaded. In this context, “uniquely associated” means that the encryption key 538 associated with a particular device 512 is generally not used to encrypt media files 502 that are to be transmitted to any other device 512. For example, the first encryption key 538a is uniquely associated with the first portable device 512a, and is therefore generally not used to encrypt media files 502 that are to be transmitted to any other device 512.

A license generation module 536 generates license information 540 for each copy of the media file 502. The license information 540 generated for a particular copy of the media file 502 reflects a user license for that particular copy of the media file 502, and is therefore uniquely associated with that copy of the media file 502. In FIG. 5, the license information 540a generated for the first copy 502a of the media file 502 is uniquely associated with the first copy 502a of the media file 502, the license information 540b generated for the second copy 502b of the media file 502 is uniquely associated with the second copy 502b of the media file 502, and the license information 540n generated for the N^{th} copy 502n of the media file 502 is uniquely associated with the N^{th} copy of the media file 502.

The license information 540 is typically different for different copies of the media file 502, reflecting the fact that different users may choose to license the same media file 502 under different license terms. However, the license information 540 for two different copies of the media file 502 may be identical, if the underlying licenses themselves are identical. For example, the user of the first device 512a and the second device 512b may elect to license the same media file 502 under the same terms. In such a situation, the license information 540a associated with the first copy 502a may be identical to the license information 540b associated with the second copy 502b.

The encrypted copies 542 of the media files 502 and the license information 540 are then transmitted to the appropriate portable devices 512. In the illustrated embodiment, the first encrypted copy 542a of the media file 502 and the associated license information 540a are transmitted to the first portable device 512a. The second encrypted copy 542b of the media file 502 and the associated license information 540b are transmitted to the second portable device 512b. The N^{th} encrypted copy 542n of the media file 502 and the associated license information 540n are transmitted to the N^{th} portable device 512n.

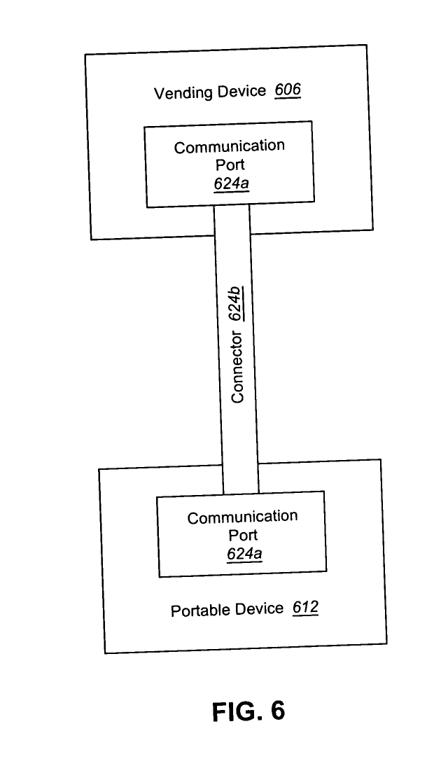

FIG. 6 is a block diagram illustrating one exemplary way in which electronic communication may occur between a vending device 606 and a portable device 612. As stated previously, a portable device 612 typically includes a communication interface 624 for electronic communication with a vending device 606, and vice versa. FIG. 6 is provided to illustrate that the communication interface 624 may include a physical connection between the vending device 606 and the portable device 612.

As shown, the communication interface 624 may include a communication port 624a, typically a high-speed communication port 624a (for example, one that conforms to the IEEE 1394 standard). Typically, both the vending device 606 and the portable device 612 include such a communication port 624a. The communication interface 624 may also include a connector 624b for connecting the communication port 624a to a corresponding communication port 624a on another device. The connector 624b may be embodied as a plug, socket, electrical cable, or the like. For example, the vending device 606 may include a socket, and the portable device 612 may include a plug that connects into the socket (or vice versa). Alternatively, both the vending device 606 and the portable device 612 may include sockets, and a cable (with plugs attached to both ends) may be used to connect the two.

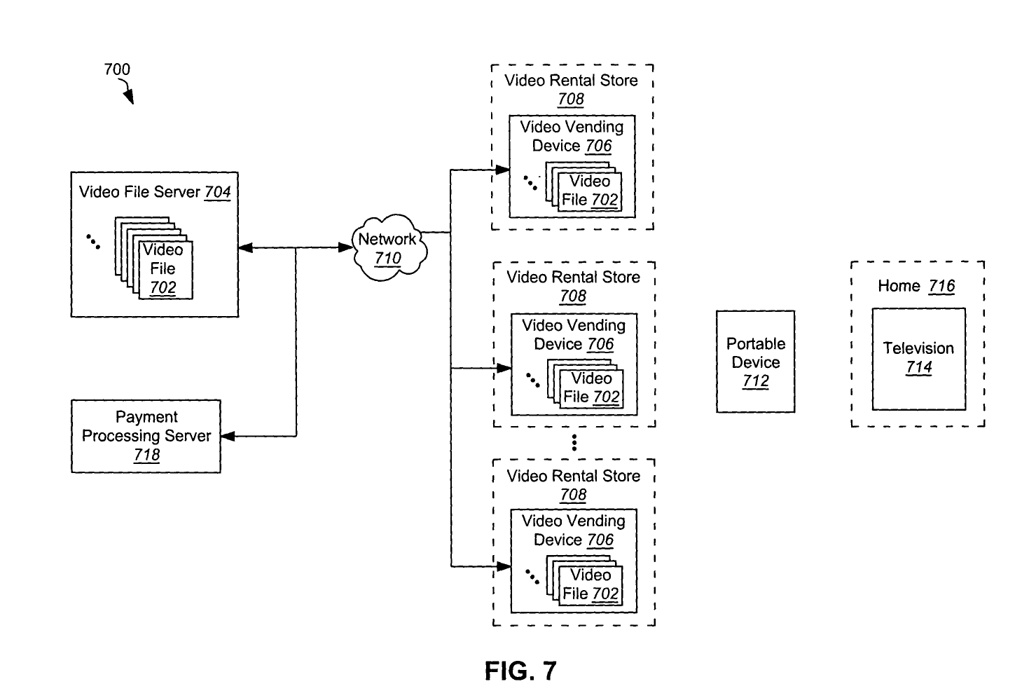

FIG. 7 is a block diagram illustrating an alternative embodiment of a system 700 for distributing digital media files 702. In the system 700 shown in FIG. 7, the media files 702 take the form of video files 702, and the vending devices 706 are located at video rental stores 708. Examples of video rental stores 708 include Hollywood Video®, Blockbuster®, and the like.

An individual who wishes to watch a movie may take his or her portable device 712 to a video rental store 708. One or more video files 702 may be downloaded to the portable device 712 in accordance with the exemplary methods described previously. The individual may then take the portable device 712 to his or her home 716, where the portable device 712 may be used to play the video file 702 on a television 714. Alternatively, the individual may choose to simply view the video file 702 on the portable device 712.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. In a media vending device, a method for distributing digital media files, comprising:
receiving a digital media file;
storing the digital media file;
receiving a request to transmit a copy of the digital media file to a portable electronic device;
determining license information that is uniquely associated with the copy of the digital media file; and
transmitting the copy of the digital media file and the license information to the portable electronic device.

2. The method of claim 1, wherein media vending device receives the digital media file from a media file server via electronic communication, wherein the media file server has a plurality of digital media files stored thereon, and wherein a plurality of other media vending devices are also in electronic communication with the media file server.

3. The method of claim 1, wherein the media vending device is located at a public location.

4. The method of claim 1, wherein the digital media file is a video file.

5. The method of claim 4, wherein the media vending device is located at a video rental store.

6. The method of claim 1, further comprising encrypting the copy of the digital media file using an encryption key that is uniquely associated with the portable electronic device.

7. The method of claim 1, further comprising providing information to a user about available digital media files.

8. The method of claim 1, further comprising:
providing a user with a plurality of license options for the digital media file; and
receiving a user selection of one of the plurality of license options, wherein the license information is determined based on the selected license option.

9. The method of claim 1, further comprising:
receiving payment information from a user; and
transmitting the payment information to a payment processing server.

10. In a portable electronic device, a method for obtaining and using digital media files, comprising:
receiving a copy of a digital media file from a media vending device;
receiving license information from the media vending device, wherein the license information is uniquely associated with the copy of the digital media file;
receiving a request from a user to produce a user-perceptible form of the digital media file;
determining whether the license information permits fulfillment of the request; and
fulfilling the request if the license information permits fulfillment of the request.

11. The method of claim 10, wherein the media vending device is in electronic communication with a media file server having a plurality of digital media files stored thereon, and wherein a plurality of other media vending devices are also in electronic communication with the media file server.

12. The method of claim 10, wherein the digital media file is a video file.

13. The method of claim 10, wherein fulfilling the request comprises producing the user-perceptible form of the media file on an output device that is part of the portable electronic device.

14. The method of claim 10, wherein fulfilling the request comprises producing the user-perceptible form of the media file on a separate output device.

15. The method of claim 10, wherein the copy of the digital media file is encrypted using an encryption key that is uniquely associated with the portable electronic device, and further comprising decrypting the copy of the digital media file.

16. A media vending device for distributing digital media files, comprising:
a processor;
memory in electronic communication with the processor;
a portable electronic device communication interface for electronic communication with a portable electronic device;
instructions stored in the memory, the instructions being executable by the processor to implement a method comprising:
receiving a digital media file;
storing the digital media file in the memory;
receiving a request to transmit a copy of the digital media file to the portable electronic device;
determining license information that is uniquely associated with the copy of the digital media file; and
transmitting the copy of the digital media file and the license information to the portable electronic device via the portable electronic device communication interface.

17. The media vending device of claim 16, further comprising a media file server communication interface for electronic communication with a media file server having a plurality of digital media files stored thereon, wherein a plurality of other media vending devices are also in electronic communication with the media file server, and wherein the digital media file is received via the media file server communication interface.

18. The media vending device of claim 16, wherein the media vending device is located at a public location.

19. The media vending device of claim 16, wherein the digital media file is a video file.

20. The media vending device of claim 19, wherein the media vending device is located at a video rental store.

21. The media vending device of claim 16, wherein the method further comprises encrypting the copy of the digital media file using an encryption key that is uniquely associated with the portable electronic device.

22. The media vending device of claim 16, further comprising an output device, and wherein the method further comprises providing information to a user about available digital media files via the output device.

23. The media vending device of claim 16, further comprising an output device and an input device, and wherein the method further comprises:
providing a user with a plurality of license options for the digital media file via the output device; and
receiving a user selection of one of the plurality of license options via the input device, wherein the license information is determined based on the selected license option.

24. The media vending device of claim 16, further comprising an input device and a payment processing server communication interface for electronic communication with a payment processing server, and wherein the method further comprises:
receiving payment information from a user via the input device; and
transmitting the payment information to the payment processing server via the payment processing server communication interface.

25. The media vending device of claim 16, wherein the portable electronic device communication interface comprises a communication port and a connector configured to electrically connect the communication port to a corresponding communication port on the portable electronic device.

26. A portable electronic device for obtaining and using digital media files, comprising:
a processor;
memory in electronic communication with the processor;
a media vending device communication interface for electronic communication with a media vending device;
an input device;
instructions stored in the memory, the instructions being executable by the processor to implement a method comprising:
receiving a copy of a digital media file from the media vending device via the media vending device communication interface;
receiving license information from the media vending device via the media vending device communication interface, wherein the license information is uniquely associated with the copy of the digital media file;
receiving a request from a user via the input device to produce a user-perceptible form of the digital media file;
determining whether the license information permits fulfillment of the request; and
fulfilling the request if the license information permits fulfillment of the request.

27. The portable electronic device of claim 26, wherein the media vending device is in electronic communication with a media file server having a plurality of digital media files stored thereon, and wherein a plurality of other media vending devices are also in electronic communication with the media file server

28. The portable electronic device of claim 26, wherein the digital media file is a video file.

29. The portable electronic device of claim 26, further comprising an output device, and wherein fulfilling the request comprises producing the user-perceptible form of the video file on the output device.

30. The portable electronic device of claim 26, wherein fulfilling the request comprises producing the user-perceptible form of the media file on a separate output device.

31. The portable electronic device of claim 26, wherein the copy of the digital media file is encrypted using an encryption key that is uniquely associated with the portable electronic device, and wherein the method further comprises decrypting the copy of the digital media file.

32. The portable electronic device of claim 26, wherein the media vending device communication interface comprises a communication port and connector configured to electrically connect the communication port to a corresponding communication port on the media vending device.
